(19) United States
(12) Patent Application Publication
(10) Pub. No.: US 2015/0262107 A1
(43) Pub. Date: Sep. 17, 2015

(54) CUSTOMER EXPERIENCE MEASUREMENT SYSTEM

(71) Applicant: INFOSYS LIMITED, Bangalore (IN)

(72) Inventors: Abhishek Singh, Noida (IN); Mani Mahesh, Frisco, TX (US); Ramakrishna Kamath, Shimoga (IN)

(73) Assignee: INFOSYS LIMITED, Bangalore (IN)

(21) Appl. No.: 14/206,933

(22) Filed: Mar. 12, 2014

(51) Int. Cl. G06Q 10/06; H04L 29/08

(52) U.S. Cl. CPC G06Q 10/06393; H04L 67/10

(57) ABSTRACT

A system and method for measuring customer experience levels across various phases of customer journey comprising a web server, a client device, a database and a network are described. The customer experience levels are obtained by collecting data from the organization around products, processes and personnel. Metrics may be defined to measure and track performance of same. The metrics may be categorized as core and secondary based on the impact to organization's cost, revenue and/or operating efficiency. The metrics may be aligned along the dimensions of digital, interaction and product experience types and may also be aligned to numerous touch-points with which the customer may interact during the customer journey. The weighted average of all the constituent metrics gives measure of total experience index which helps the organization to measure and monitor the state of customer experience and improve the levels of customer experience for the business profitability.

### FIELD OF TECHNOLOGY

This disclosure relates generally to the field of customer experience measurement and, more particularly, to customer experience measurement through analytics.

### BACKGROUND

The rapid adoption of the Internet and other communication technologies over the last decade has changed the way people and businesses operate. There are certain challenges faced by businesses if they are to serve the prospective customers effectively.

Organizations strive to serve customers in the best way possible by providing a truly unique and satisfying experience. Providing such a unique and satisfying experience to every customer is only possible if the business customizes and/or personalizes business's services according to the customer's needs. To customize the services, businesses must understand the customers, customer needs, intent of the customer, and so on to be able to offer a right experience to the customer.

Current approaches for assessing customer experience are customer service interactions and surveys. Customer interactions focus on recording an interaction and analyzing previously identified operational metrics and typically does not involve all the information that may be important to an individual customer. Customer surveys are limited to quantifiable answers indicated within checkboxes and do not convey enough information for robust analysis. Indeed, traditional approaches often provide not so useful information.

The existing products/systems/processes in the market today measure the customer experience at an individual (end user's) level and cater to either a website/online experience and/or a customer support/service experience. Existing systems fail to provide a holistic measure of organization's customer experience and impact to the organization's revenue, operational efficiencies and/or profits.

### SUMMARY

Disclosed are a method, an apparatus and/or a system to measure customer experience across various phases of customer and organization interaction.

In one aspect, a method for measuring customer experience includes obtaining customer experience levels using the organization's data around product, processes and personnel. Metrics may be defined to measure performance of the product, processes and personnel. The aforementioned metrics may be aligned to digital, interaction and product experience types. A total experience index (TEI) may be calculated using a weighted average of constituent metrics across each experience types. A customizable dashboard providing the measurement of total experience index to the organization may be generated.

The metrics may be categorized as core and secondary metrics based on the impact to the organization's cost revenue and/or operating efficiency. The metrics may also be aligned to different touch-points with which the customer may interact during the customer journey.

The metrics pertaining to the particular touch-point may be presented to the organization to monitor and access the touch-point's contribution to the organization's revenue. Thresholds may be set against the metrics being tracked by allowing the metrics to track lapses in the customer experience against set thresholds. Further, tracking of websites may be automated by setting alerts against the metrics.

A fully customizable dashboard provides measurement of the total experience index to the organization. Scores for different experiences and the constituent metrics are represented by the dashboard.

In another aspect, the method of measuring customer experience may be integrated with a customer relationship management function of the organization to aggregate customer segmentation details.

In another aspect, the method improves the quality of the customer experience resulting in higher profitability for the organization.

In another aspect, a system for measuring customer experience includes obtaining customer experience levels using the organization's data around the organization's product, processes and personnel. Metrics may be defined to measure performance of the product, processes and personnel. The aforementioned metrics may be aligned to digital, interaction and product experience types. A total experience index (TEI) may be calculated using a weighted average of constituent metrics across each experience types. A customizable dashboard providing the measurement of total experience index to the organization may be generated. The metrics may be categorized as core and secondary metrics, aligned to the different touch-points. The metrics being tracked are set against thresholds and tracking of the websites may be automated by setting alerts against the metrics. The scores and the constituent metrics may be represented by the customizable dashboard. The system may be interfaced with the organization's customer relationship management function to retrieve customer segmentation details and improves the quality of the customer experience resulting in higher profitability for the organization.

### BRIEF DESCRIPTION OF THE DRAWINGS

Example embodiments are illustrated by way of example and not limitation in the figures of the accompanying drawings, in which like references indicate similar elements and in which:

FIG. 1 is a system diagram of one embodiment.

FIG. 2 shows implementation of an exemplary embodiment;

FIG. 3 shows lifecycle of an airline customer, according to one embodiment.

FIG. 4 shows exemplary dashboard, according to one embodiment.

FIG. 5 shows various filters and user views of the dashboard, according to one or more embodiment.

FIG. 6 shows different core and secondary metrics with thresholds.

FIG. 7 is a diagrammatic representation of a data processing system capable of processing a set of instructions to perform any one or more of the methodologies herein, according to one embodiment.

FIG. 8 is a process flow diagram of the method for measuring customer experience levels, according to one embodiment.

Other features of the present embodiments may be apparent from the accompanying drawings and from the detailed description that follows.

### DETAILED DESCRIPTION

Example embodiments, as described below, may be used to provide a method, a framework or a system to measure holistic customer experience across various phases of customer journey. Although the present embodiments have been described with reference to specific example embodiments, it may be be evident that various modifications and changes may be made to the embodiments without departing from the broader spirit and scope of the various embodiments.

The present technology may be directed to systems, methods, and framework to generate and display customer experience levels. Broadly, the customer experience measurement system empowers the organization to optimize the customer experience with a data driven approach to decision-making. The customer experience measurement system provides real-time predictive measures and robust insights to improve quality of the customer experience resulting in higher profitability for the organization.

The embodiments herein disclose a framework which leverages big data analytics, i.e. analytics applied to a collection of data sets so large and complex that it becomes difficult to process using on-hand database management tools or traditional data processing applications, to anticipate customer needs through sophisticated predictive analytics that predict the intent of the customer.

In one or more embodiments, the customer experience means sum of all experiences a customer has with a provider of goods and/or services, over the duration of relationship with the provider. The customer experience might include awareness, discovery, attraction, interaction, purchase, use, cultivation and advocacy.

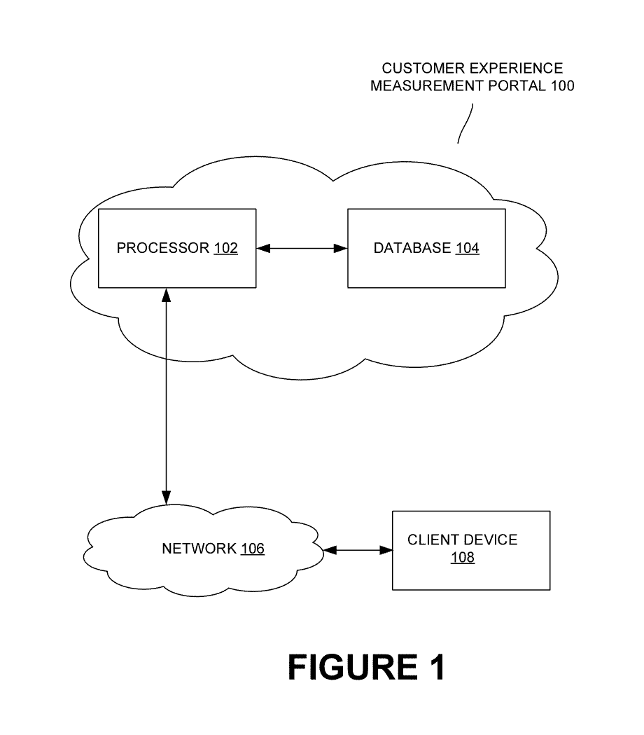

FIG. 1 refers to a system of customer experience measurement, the system may be implemented to collect and evaluate customer experience levels. The system may be facilitated by a customer experience measurement portal 100, hereinafter referred as “system 100” as shown in FIG. 1. The system 100 may generally be described as including one or more web servers 102 that may communicatively couple with client devices 108 such as end user computing systems. The system 100 of FIG. 1 may be depicted as showing only one web server 102 and one client device 108 that are communicatively coupled with one another via a network 106 in an example embodiment. Additionally, the customer experience levels gathered from various sources (not depicted in FIG. 1) may be stored in database 104, along with various scores, values, and the corresponding data generated by the web server 102, as will be discussed in greater detail below. It is noteworthy to mention that the network 106 may include any one (or combination) of private or public communications networks such as the Internet. The client device 108 may interact with the web server 102 via a web based interface, or an application resident on the client device 108, as will be discussed in greater detail herein.

The system 100 may be described as a particular purpose computing environment that includes executable instructions that are configured to generate and display the customer experience levels. In some embodiments, the web server 102 may include the executable instructions in the form of an application, hereinafter referred to as “application 200” that collects and evaluates the customer experience levels across various phases of the customer journey.

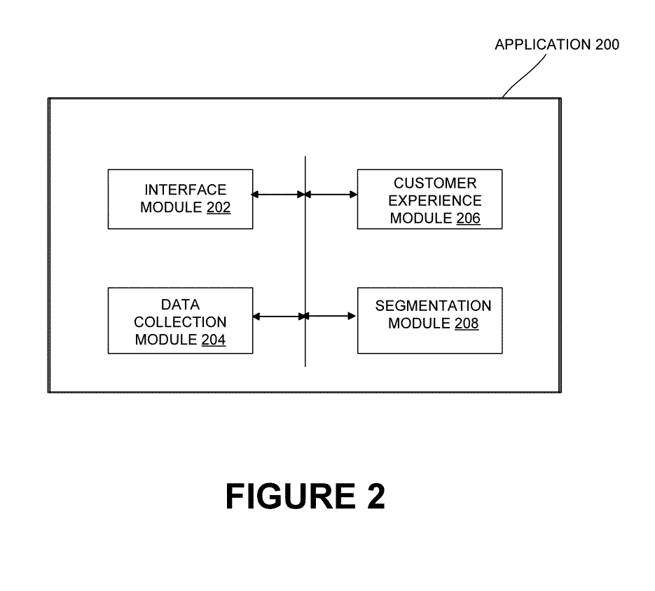

FIG. 2 illustrates exemplary schematic diagram of the application 200. The application 200 may be shown as comprising an interface module 202, a data collection module 204, a customer experience module 206, and a segmentation module 208. The application 200 may include additional modules, engines, or components, and still fall within the scope of the present technology. As used herein, the term “module” may also refer to any of an application-specific integrated circuit (ASIC), an electronic circuit, a processor (shared, dedicated, or group) that executes one or more software or firmware programs, a combinational logic circuit, and/or other suitable components that provide the described functionality. In other embodiments, individual modules of the application 200 may include separately configured web servers.

The user interface module 202 may generate a plurality of graphical user interfaces that allow end users to interact with the application 200. The graphical user interfaces may allow the end users to input information that may be utilized by the system 100 to capture and analyze the customer experience levels. The information input by the end users may include product information, process information and personnel information, the end users desire to evaluate. Also, the user may input product lifecycle or a portion of the product cycle of interest, the type of consumers or messages desired to analyze, and so forth as described in one or more embodiments.

In one or more embodiments, the data collection module 204 may gather existing data in the organization around the product, process and personnel to define metrics and measure and track the performance. The term ‘metrics’ may be defined as standards of measurement by which efficiency, performance, progress, or quality of a plan, process, employee or product may be assessed. The metrics may be aligned to different experience types along the dimensions of digital, interaction and product experiences. The metrics may be categorized into core and secondary based on the impact to the organization's cost revenue and/or operating efficiency. The digital experience may be defined as anywhere the customer may interact with technology of the company. The interaction experience may be defined as anywhere the customer may interact with an employee of the company like call center. The product experience may be defined as anywhere the customer may interact with a product of the company.

The metrics may also be aligned to numerous touch-points with which the customer may interact with the organization across the various phases of the customer journey.

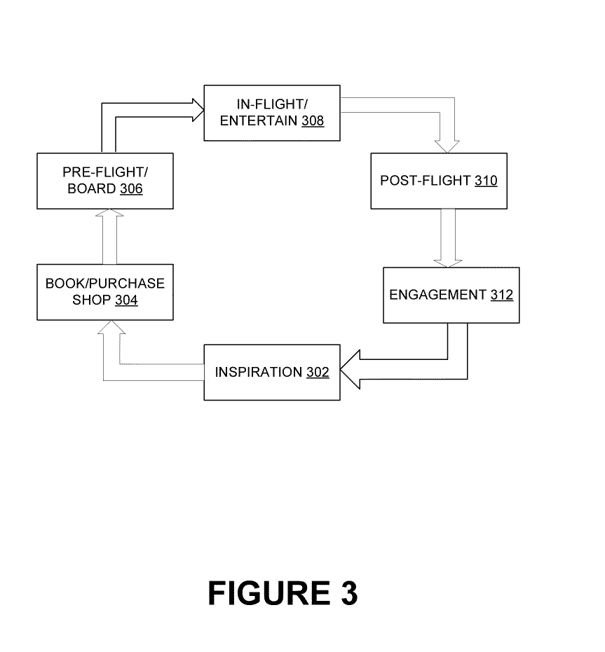

FIG. 3 illustrates lifecycle of customer journey for an airline customer in an example embodiment. It illustrates various phases such as inspiration 302, book/purchase shop 304, pre-flight/board 306, in-flight/entertain 308, post flight 310 and engagement 312.

In one or more embodiments, the aforementioned system 100 provides the organization holistic measure of the customer experience levels through total experience index (TEI), which is weighted average of different core and secondary metrics along the dimensions of the digital, interaction and product experience types. The system 100 identifies five core metrics for each of the above experience categorizations. The core metrics may be arrived at based on the relative importance to the organization's cost, revenue or operating efficiency. The organization may alter the list of the core metrics based on the actual relevance of the metrics in the calculation of total experience index at a particular point in time. In addition to the core metrics, the organization may define and track numerous secondary metrics or user-defined metrics for each of the experience types. The scores for all the metrics may be represented against a common scale so as to abstract the user from the underlying intricacies involved in understanding the different scores.

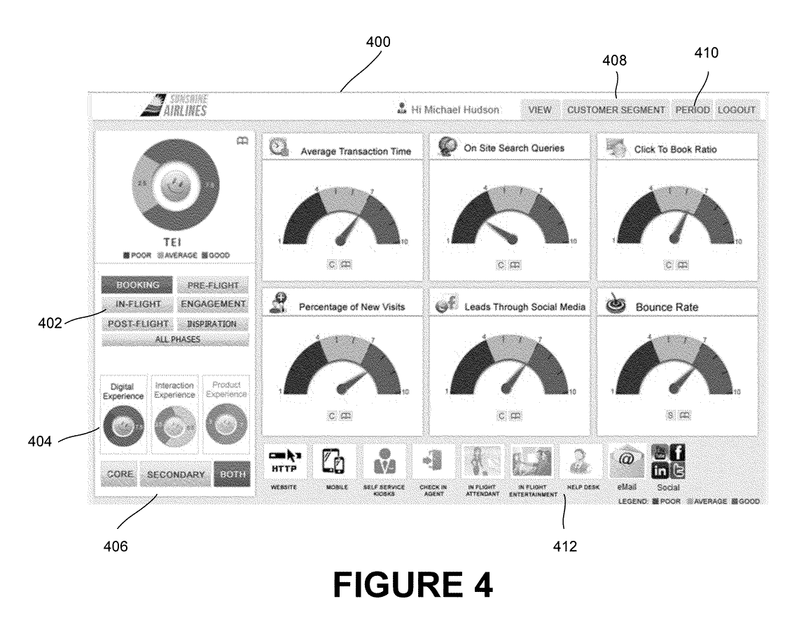

FIG. 4 illustrates exemplary graphical user interfaces in the form of customizable visual dashboard 400. The dashboards are merely exemplary and are representative of the many types of GUIs that may be generated by the system 100. Thus, one ordinary skill in the art will appreciate the exact types of customer experience data, and arrangement of the customer experience data into the visual dashboard 400 may depend upon the type of information relevant to the user. Thus, the customer experience level for the product or service may be visually represented, graphically, according to customer segments or time period.

In the exemplary embodiment, FIG. 4 describes customizable visual dashboard 400 representing the scores for all the metrics. The dashboard 400 displays various filters such as customer journey 402, different experience types 404, metric type 406, customer segment 408, period/time range 410 and numerous touch-points 412 with which the customer may interact. The visual dashboard 400 has numerous filters to narrow down on the required level of detail. The customer journey 402 represents the different stages at which the customer may interact with the organization throughout his/her engagement with the organization. Generally, the stages may be categorized as awareness, research, evaluate, purchase and engagement. In the exemplary embodiment the stages illustrated may be inspiration 302, book/purchase shop 304, pre-flight/board 306, in-flight/entertain 308, post flight 310 and engagement 312. The organization may view the data on the dashboard 400 for a particular customer segment of interest. The application 200 may interface with the customer relationship management function of the organization to gather customer segmentation details. The metrics in the dashboard 400 may be viewed for different period/time range 410 as needed by the user. The dashboard 400 may be customized to show the metrics for a particular touch-point such as website, mobile, self-service kiosks, email and social networking services. The social networking services may be Facebook™, Twitter® or YouTube™. The user may restrict the metric type 406 to core, secondary or both as needed. The user may view the metrics associated with different experience type 404. Different experience types 404 may be digital experience, interaction experience and product experience as shown in FIG. 4.

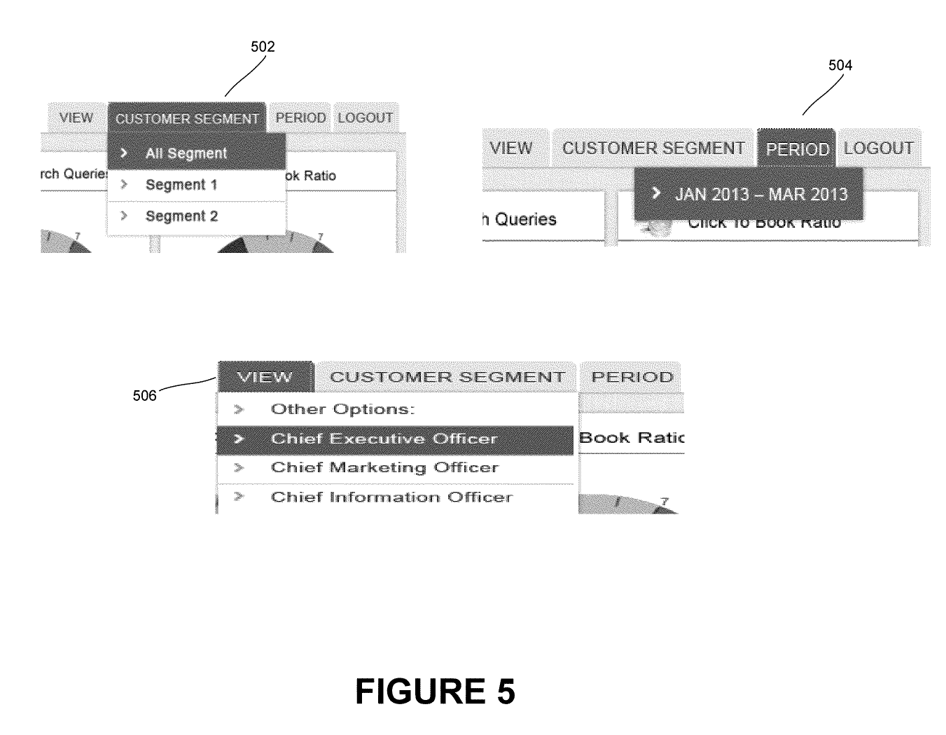

FIG. 5 illustrates various user controls ‘Customer segment 502’ and ‘Period 504’ of the dashboard 400 that may allow the user to view the metrics for particular customer segment of interest over a period of time. The period of time may be a week, month, quarter, and year or date range in one or more embodiments.

The dashboard 400 may load up with the default set of metrics for a particular category of user (chief executive officer, chief marketing officer, chief information officer etc.) under the user control ‘View 506’.

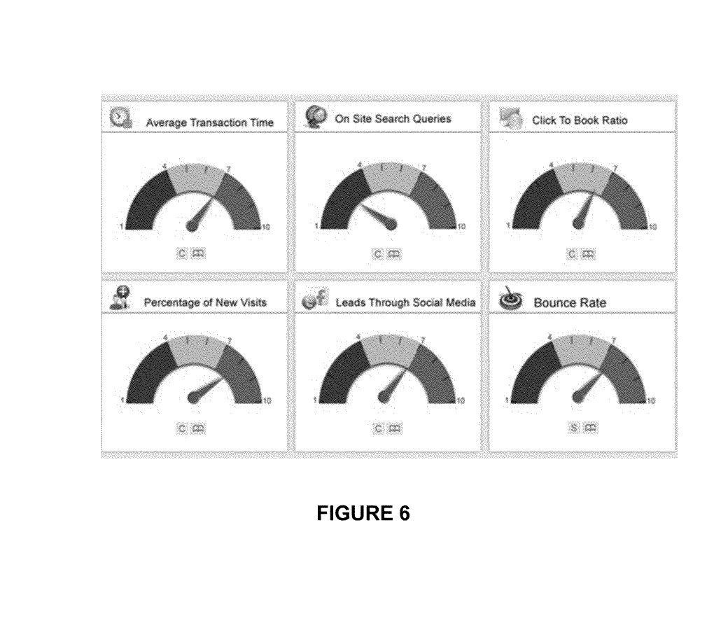

FIG. 6 illustrates different core metrics for the digital experience type. The different core metrics for the digital experience type may be Average Transaction Time, On-Site Search Queries, Click To Book Ratio, Unsubscribe rate for the Emails and Social Media Reach. Likewise, different core metrics for the interaction experience type and product experience type may be First Call Resolution Rate, Average Issue Resolution Time, Self Service Effectiveness, Service Level, Blockage and Product Utilization, Product Availability, Product Complaints, Product Assistance, Aggregate review score for the Product from Social Media respectively. At periodic intervals, the list of core and secondary metrics may be revisited and based on the current impact of the metrics on the organization; the list may be re-arranged as required.

Apart from the above mentioned filters, the scores for each of the metrics may be marked against pre-defined thresholds and each metric will have an associated analytic insights segment that may provide insights on the performance of each metric as shown in FIG. 6. The scores may be used by the organization to improve the products and services. Using the customer experience scores, the organization may define the metrics, measure the metrics, monitor the metrics and analyze the impact of such metrics on the customer experience levels. The organization may consequently analyze impact of the metrics to the business profits. Additionally, the customer experience levels may also help the organization to define benchmarks/thresholds and to get automated alerts when the thresholds may be breached as explained in one or more embodiments.

In one or more embodiments, the data collection module 204 may be executed to obtain the customer experience levels from one or more touch-point such as website, mobile, self-service kiosks, email and social networking services.

In an example embodiment, the data collection module 204 may analyze the customer experience levels to determine where within the product lifecycle a customer currently resides—for example, in inspiration 302, book/purchase shop 304, pre-flight/board 306, in-flight/entertain 308, post flight 310 and engagement 312 as shown in FIG. 3.

According to some embodiments, the customer experience module 206 may be executed to evaluate portions of the customer journey (e.g. product lifecycle) relative to the product. Customer experience values may comprise mathematical representations of the customer experience levels at specific point in time (or a specific time period) along the product lifecycle.

Various scores may be generated by the customer experience module 206 that represents the different customer experiences. The scores or values may be utilized by the organization/business to improve the products and/or services. The organization may explore the metrics in detail regarding the touch-points surrounding the product using the customer experience scores. The customer experience module 206 may also generate optimal customer journey models that enable the organization to plan effective product development while also allowing for course correction when products or services fail to produce acceptable customer experience.

According to some embodiments, the segmentation module 208 may be executed to determine and develop actionable priorities tailored to specific customer types. The segmentation module 208 may cluster customers based on a variety of factors using a segmentation model that considers the product lifecycle component and likelihood of purchasing the product. Moreover, the segmentation module 208 may also determine if the customer is influencing other customers with the social networking service. The segmentation module 208 may also use combined data to generate the models that allow segmentation module 208 to predict which social networking service may be tracked to get the most accurate and relevant information about the customer.

In other embodiments, the segmentation module 208 may utilize correlated group customers into categorizes based upon various factors. For example, very influential customers who focus on a particular product and/or service may be clustered under one segment. The clustering of customers may allow the organization to direct more resources towards the particular product and/or service.

According to various exemplary embodiments, the system 100 may be configured to generate and display the customer experience scores. The customer experience levels empowers the organization to optimize the customer experience with a data-driven approach to decision-making. The customer experience data provides real-time predictive measures and robust insights to strengthen customer experience around three exemplary customer journeys, including shopping, sharing and advocacy. The customer experience data may be utilized by the system 100 to provide the user with visually appropriate and intuitive dashboards. The dashboard 400 presents the metrics in a user-friendly way.

In one or more embodiments, using the system 100 an organization may measure the state of the customer experience at a given point in time, may define targets for the organization's ideal state of the customer experience as well as measure the relationship of customer experience metrics with business profitability. The system 100 may help the organization to assess the impact of the customer experience metrics on the organization's cost, revenue and/or operating efficiency thereby helping the organization to improve the quality of the customer experience that the organization offers to the customers—in turn resulting in higher profitability for the organization.

The core metric score for each of the experience type may be the cumulative score for the constituent core metrics. There may be 5 core metrics for each of the experience type. Each individual metric may be represented on a scale of 10 and the core metric score for each of the experience type may be the average of the five core metrics for the respective experience type. An exemplary equation for calculation of the core metrics is provided below:

C_{DX} or C_{IX} or C_{PX}=(C₁+C₂+C₃+C₄+C₅)/5

Where, C_{DX}, C_{IX} and C_{PX} are the core metric scores for the digital, interaction and product experiences respectively and C₁, C₂, C₃, C₄ and C₅ are the core metrics for each of the experience type.

The secondary metric score for each experience type may be the cumulative score for the constituent secondary metrics. There may be any number of secondary metrics for each of the experience type. Each individual metric may be represented on a scale of 10 and the secondary metric score for each of the experience type is the average of the individual secondary metric scores for the respective experience type. An exemplary equation for calculation of the secondary metrics is provided below:

S_{DX} or S_{IX} or S_{PX}=(S₁+S₂+S₃+ - - - +S_{N-1}+S_{N})/N

Where, S_{DX}, S_{IX} and S_{PX} are the secondary metric scores for the digital, interaction and product experiences respectively and S₁, S₂, S₃, S₄ etc. are the secondary metrics for each of the experience type.

The weighted scores for each experience categorization may be the weighted average of the core and secondary metrics score. The weights may be in the ratio of 7:3.

W_{DX}=(7(C_{DX})+3(S_{DX}))/10

W_{IX}=(7(C_{IX})+3(S_{IX}))/10

Where, W_{DX} and W_{IX} are the weighted scores for the Digital and Interaction experience respectively

W_{IPX}=(7(C_{PX})+3(S_{PX}))/10

Where, W_{IPX} is the weighted score for an Individual product. The collective Product Experience score is calculated as below:

W_{PX}=ΣW_{IPX}/N(Where N is the number of individual products)

The Total Experience Index, TEI, may be the average of the weighted scores for individual experiences. It may be measured on a scale of 10.

TEI=(W_{DX}+W_{IX}+W_{PX})/3

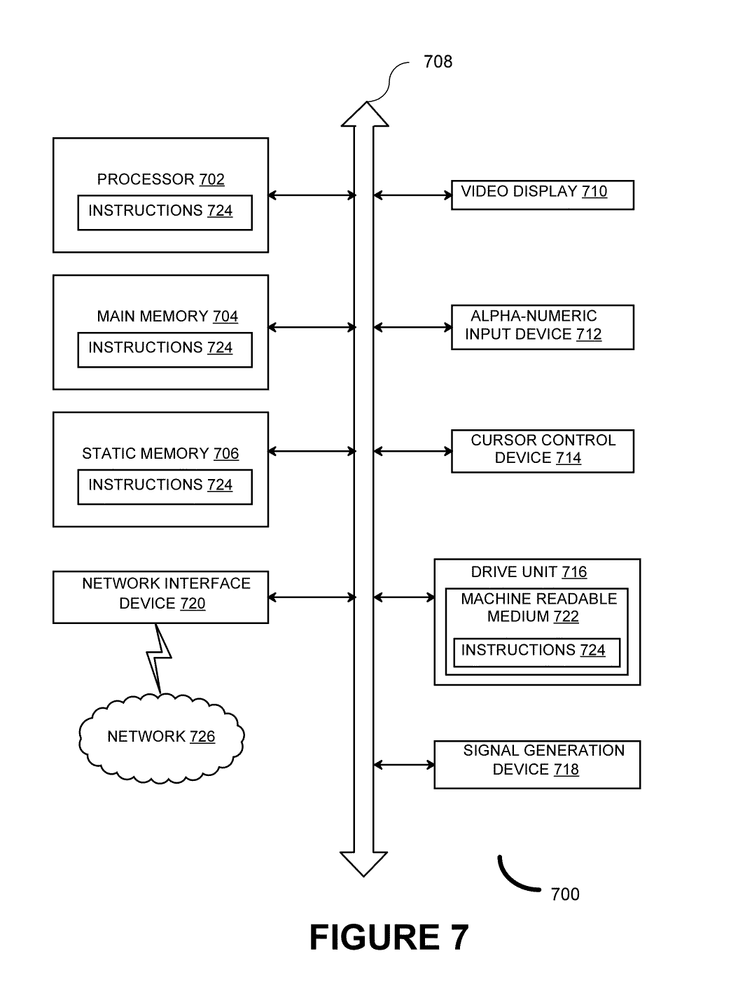

FIG. 7 is a diagrammatic representation of a data processing system capable of processing a set of instructions to perform any one or more of the methodologies herein, according to an example embodiment. FIG. 7 shows a diagrammatic representation of machine in the example form of a computer system 700 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal displays (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions 724 (e.g., software) embodying any one or more of the methodologies and/or functions described herein. The instructions 724 may also reside, completely and/or at least partially, within the main memory 704 and/or within the processor 702 during execution thereof by the computer system 700, the main memory 704 and the processor 702 also constituting machine-readable media.

The instructions 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical media, and magnetic media. Carrier-wave signals can also carry instructions for any of the methods described herein.

Computer-readable media can take the form of any of the machine-readable media described herein and can comprise computer-executable instructions causing a computing system (e.g., comprising one or more processors and memory coupled thereto) to perform any of the methods described herein.

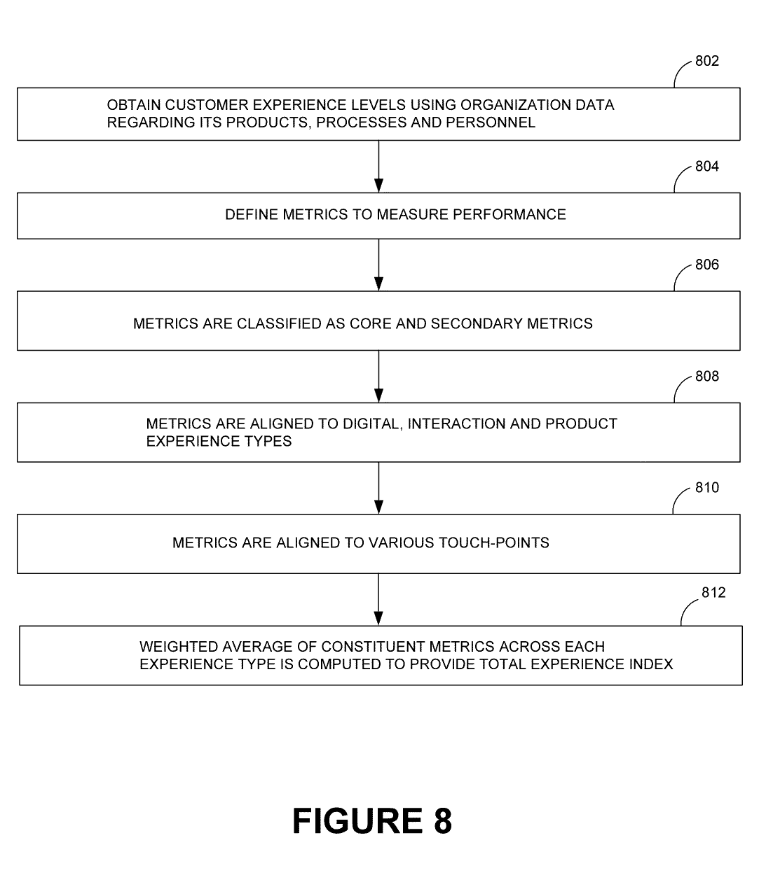

FIG. 8 describes logical flow diagram illustrating detailed operation of the method used by the system 100 in an exemplary embodiment as shown in FIG. 1. The method begins at block 802 where the customer experience levels are obtained from the organization data around the organization's products, processes and personnel. At step 804, the metrics are defined to measure and track performance. The metrics are classified into the core and secondary metrics based upon on relative impact to the organization's cost, revenue and/or operating efficiency at step 806. The metrics are aligned to the digital, interaction and product experience types at step 808 and also aligned to the numerous touch-points such as websites, mobile, self-service kiosks, email and social networking service at step 810. At step 812, the weighted average of the constituent metrics is calculated to determine the total experience index.

In addition, it will be appreciated that the various operations, processes, and methods disclosed herein may be embodied in a machine-readable medium and/or a machine accessible medium compatible with a data processing system (e.g., a computer system), and may be performed in any order. The modules in the figures are shown as distinct and communicating with only a few specific module and not others. The modules may be merged with each other, may perform overlapping functions, and may communicate with other modules not shown to be connected in the Figures. Accordingly, the specification and drawings are to be regarded in an illustrative rather than a restrictive sense.

What is claimed is:

1. A method for measuring customer experience, comprising:
providing a customer experience measurement portal, wherein said customer experience measurement portal comprises a processor, a database coupled to the said processor and a network interface;
obtaining, by the processor, customer experience levels through data in an organization around at least one selected from the group consisting of products, processes and personnel;
defining, by the processor, at least one metric to measure performance of the at least one selected from the group consisting of products, processes and personnel;
aligning, by the processor, the at least one metric to experiences along dimensions of digital, interaction and product experience types;
calculating, by the processor, a total experience index through a weighted average of the at least one metric across each of the experience types; and
providing an organization a measurement of the total experience index.

2. The method of claim 1, wherein the at least one metric is categorized into core and secondary based on at least one of an impact to cost, revenue and operating efficiency of the organization.

3. The method of claim 2, wherein the at least one metric is aligned to at least one touch-point with which a customer interacts.

4. The method of claim 3, wherein the at least one metric pertaining to the at least one touch-point is presented to the organization to monitor and assess contribution to revenue of the organization of the at least one touch-point.

5. The method of claim 1, further comprising:
setting at least one threshold value for the at least one metric, wherein the at least one metric is tracked to note lapses in the customer experience levels against the threshold value; and
generating, a fully customizable dashboard, which provides the organization the measurement of the total experience index.

6. The method of claim 1, further comprising:
tracking of websites by setting alerts against the at least one metric.

7. The method of claim 5, further comprising:
customizing the dashboard based on inputs provided by a user.

8. The method of claim 7, wherein the user inputs comprise at least one touch-point, a customer segment of interest and time ranges.

9. The method of claim 8, wherein the dashboard shows at least one metric for the at least one touch-point including at least one selected from the group consisting of a website, a mobile, self-service kiosks, an email and social network services.

10. The method of claim 1, wherein customer segmentation details are gathered by integrating with customer relationship management function of the organization.

11. A system, comprising:
a customer experience measurement portal having a processor, a database coupled to the processor and a network interface, to perform operations comprising:
obtaining, by the processor, customer experience levels through data in an organization around at least one selected from the group consisting of products, processes and personnel;
defining, by the processor, at least one metric to measure performance of the at least one selected from the group consisting of products, processes and personnel;
aligning, by the processor, the at least one metric to experiences along dimensions of digital, interaction and product experience types;
calculating, by the processor, a total experience index through a weighted average of the at least one metric across each of the experience types; and
providing an organization a measurement of the total experience index.

12. The system of claim 11, wherein the at least one metric is categorized into core and secondary based on at least one of an impact to cost, revenue and operating efficiency of the organization.

13. The system of claim 11, wherein the at least one metric are aligned to at least one touch-point with which a customer interacts.

14. The system of claim 13, wherein the at least one metric pertaining to the at least one touch-point is presented to the organization to monitor and assess contribution to revenue of the organization of the at least touch-point.

15. The system of claim 11, wherein at least one threshold value is set for the at least one metric, wherein the at least one metric is tracked to note lapses in the customer experience levels against the at least one threshold value; and
a fully customizable dashboard, is generated to provide an organization the measurement of the total experience index.

16. The system of claim 15, wherein the operations further comprise:
tracking of websites by setting alerts against the at least one metric.

17. The system of claim 15, wherein the operations further comprise:
customizing the dashboard based on inputs provided by a user.

18. The system of claim 17, wherein the user inputs comprise a touch-point, a customer segment of interest and time ranges.

19. The system of claim 15, wherein the dashboard shows at least one metric for at least one touch-point including at least one selected from the group consisting of a website, a mobile, self-service kiosks, an email and social network services.

20. The system of claim 11 the operations further comprise:
interfacing with a customer relationship management function of the organization to gather customer segmentation details.

21. One or more computer-readable media comprising computer-executable instructions causing a computing system to perform a method for measuring customer experience, the method comprising:
providing a customer experience measurement portal;
obtaining customer experience levels through data in an organization around at least one selected from the group consisting of products, processes and personnel;
defining at least one metric to measure performance of the at least one selected from the group consisting of products, processes and personnel;
aligning the at least one metric to experiences along dimensions of digital, interaction and product experience types;
calculating a total experience index through a weighted average of the at least one metric across each of the experience types; and
providing an organization a measurement of the total experience index.
